(19) United States
(12) Patent Application Publication
(10) Pub. No.: US 2015/0314463 A1
(43) Pub. Date: Nov. 5, 2015

(54) INTEGRATED SHAVER

(71) Applicant: ONYEKWERE MGBEAHURIKE, ALBUQUERQUE, NM (US)

(72) Inventor: ONYEKWERE MGBEAHURIKE, ALBUQUERQUE, NM (US)

(21) Appl. No.: 14/267,531

(22) Filed: May 1, 2014

(51) Int. Cl. B26B 19/48; B26B 19/40; B26B 19/38

(52) U.S. Cl. CPC B26B 19/48; B26B 19/382; B26B 19/40

(57) ABSTRACT

The present invention provides an integrated shaver which includes a first end with aperture for the application of a pre-shave lotion and a second end with apertures for the application of aftershave lotion. The shaver includes at least a cartridge insertable in the body of the shaver for holding the lotion. A method of use is also disclosed.

### BACKGROUND

Caring for the skin before and after shaving has been the focus of a fair section of the cosmetic industry. A typical shaving process for people with facial hair includes the application of pre-shave lotion or gel, shaving and maybe an application of an aftershave lotion or gel. In some instances, or for one reason or another, the person shaving may apply only one or the other lotion or gel before or after the shave. An unfortunate consequence of not applying either a pre-shave or aftershave lotion or gel, is bumps on the face. Bumps are essentially hair stubs curled back under the skin Some may be painful, provide ugliness of its own, become infected, or cause more lasting skin damage. In some cases, a person with reactive skin with these ill effects may avoid shaving and present an unkempt appearance.

A lot of people find the process of packing a pre-shave and aftershave cumbersome, only to find themselves in need of such at the need for a shave. There have been efforts to apply some lubricant to shaving blades, but that is only limited and some people cannot use razor blades due to skin reaction or hair texture. Air travel in the current age discourages packing too many liquid or gel containers and there are size restrictions.

From the foregoing, it will be appreciated that what is needed in the art is a shaver that is packaged to provide the capacity for a pre-shave or aftershave lotion or gel during the shaving or grooming process. Such equipment is disclosed and claimed herein.

### SUMMARY

In one embodiment the present invention provides an integrated shaver having cartridges of pre-shave or aftershave lotion that is applicable to the skin during a grooming process. The lotion or gel may be incorporated in removable cartridges adapted to fit the shaver of the present invention.

In one embodiment of the present invention, the shaver is provided with an applicator at the bottom end of the equipment and preferably dispensing aftershave lotion.

In another embodiment of the present invention, the cartridges may be adapted to push out the gel or lotion without the need to add pressure or squeeze it out.

### BRIEF DESCRIPTION OF THE DRAWINGS

FIG. 1A is a front perspective view of an embodiment of the integrated shaver according to the present invention.

FIG. 1B is a bottom perspective view of an embodiment of the integrated shaver according to the present invention.

FIG. 1C is a front perspective view of an embodiment of the integrated shaver according to the present invention showing a removal lid, removed cartridges and locations for the removed cartridges.

FIG. 2A is a front perspective view of another embodiment of the integrated shaver according to the present invention showing another form of lotion or gel cartridge.

FIG. 2B is a bottom perspective view of another embodiment of the integrated shaver according to the present invention showing another form of lotion or gel cartridge.

### DETAILED DESCRIPTION

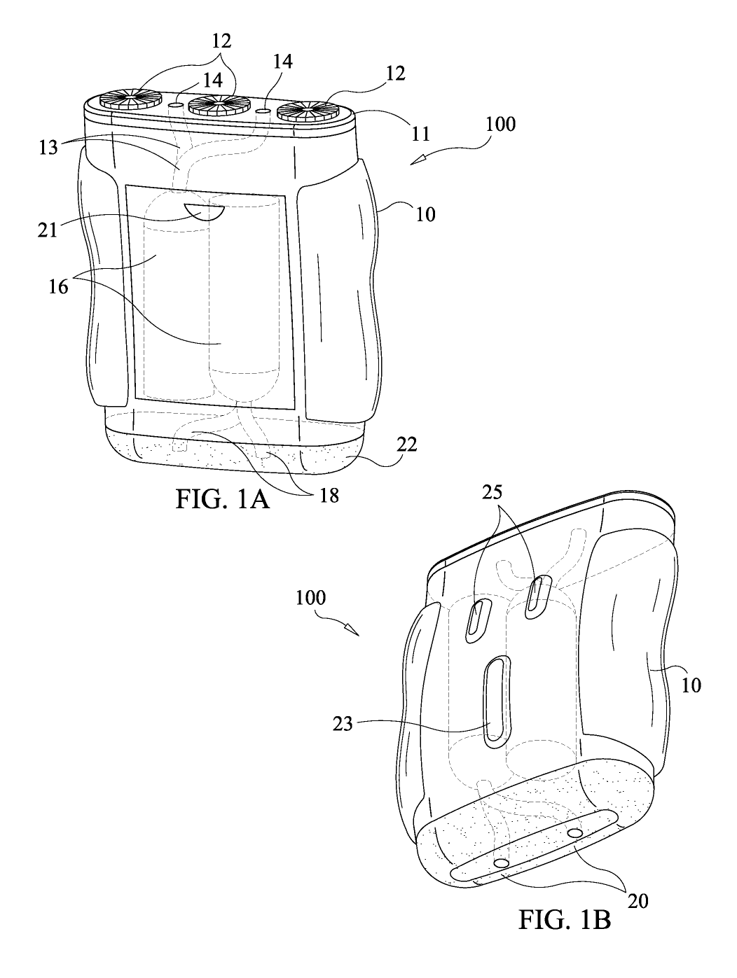

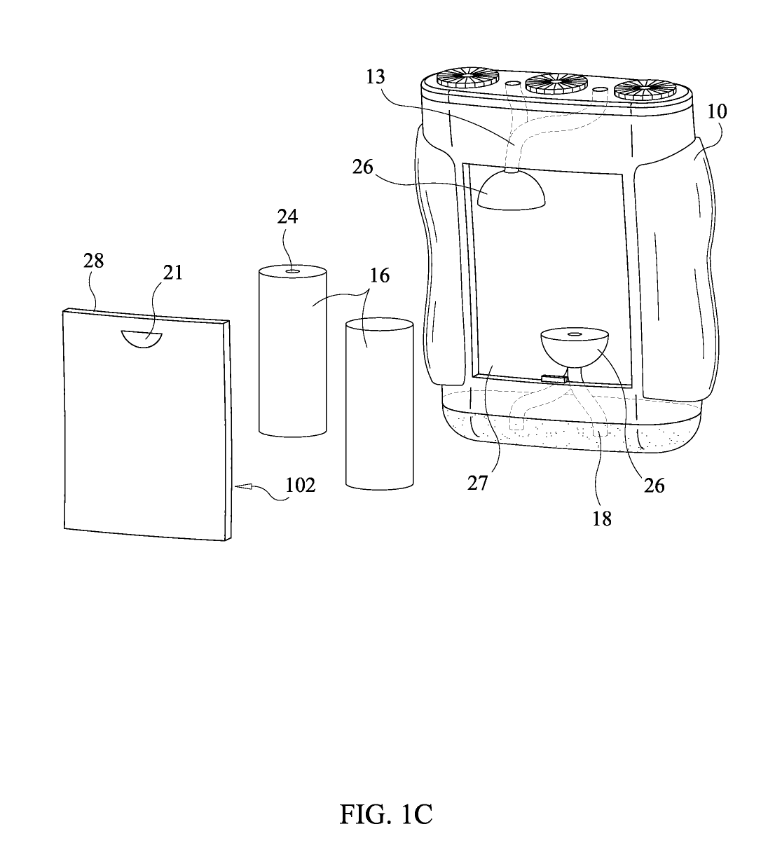

Referring to FIG. 1, an integrated shaver 100 according to the present invention is presented having a body 10 comprising a shaving head 11 with at least a cutter 12 and at least an orifice 14 suitable for delivery of a lotion, gel or cream to the face or body of user. The shaver body 10 comprises a bottom application portion 22 (preferably of a material adaptable for application of lotion, gel or cream to the body by a user. The shaver 100 of the present invention preferably has at least a cartridge, reservoir or container 16 for use in holding the gel, lotion or cream. A discharge channel 13 is adapted to convey the gel, which nomenclature shall be used interchangeably to include lotion, cream or any suitable content for the intended purpose of application to the skin of a user. A latch or opening aid 21 is preferably included to provide for the opening or necessary recharge of the cartridge 16 for the shaver 100 according to the present invention. It is informative that the discharge channel 13 is adapted to convey the gel to the top of the shaver 100. Alternatively or in combination, at least another cartridge 16 is included in the cavity wherein at least another cartridge leading upwards to the top of the shaver is presented. Said cartridge 16 may be provided with at least a discharge channel 18 adapted to convey a gel to the bottom of the shaver 22.

In the present invention, shown in FIG. 1B, at least a bottom orifice or discharge outlet 20 is presented for the application of an aft shave or suitable lotion or gel to the skin of the user. A readout button, sensing gauge or other suitable meter 23 may be included, according to the present invention. Such gauge is usable to monitor the content of the cartridges or usable to serve any needed purpose to facilitate the efficiency and effectiveness of delivering needed lotion or gel to the body of the user. The body 10 may include switches 25 usable to trigger the release or delivery of said gel to the orifice 14 or 20 of the shaver 100. The shaver 100 of the present invention may include actuators, feeding mechanisms or other delivery enhancing equipment (not shown) to facilitate the delivery of said lotion to the body of a user. It is reasonable to expect a pre-shave or similar lotion or lubricant to be charged in the cartridge provided for top delivery while an aftershave of similar lotion or gel be charged in the cartridge providing delivery to the bottom portion of the shaver 100 of the present invention. The switch 25 or meter 23 may be located on any preferable part of the shaver body 10, which may be on the opposite end or on either side of the body 10.

Now referring to FIG. 1C of the present invention, a shaver body 10 is presented with an open cavity 27 wherein the cartridges 16 are preferably located or expected to be placed. The cavity 27 provides access to hookups 26 suitably connected to discharge channels 13 and 18 for the delivery of the gel. If actuators are included, they would be located in connection and be connected to the discharge channels and adapted to facilitate the delivery of the gel. Each hookup 26 is preferably presented with an orifice suitable to attach and cooperate with the cartridge 16 for the delivery of the lotion. Similarly, the cartridge 16 of the present invention is provided with at least one orifice 24 suitable to cooperate with the hookup 26 for the delivery of the lotion. A lid portion 102 is shown in FIG. 1C with body 28 and latch 21 suitable to latch onto and fit to cover cavity 27 for the protection and closure for the cartridges 16 or other useful adaptors enclosed in said cavity 27.

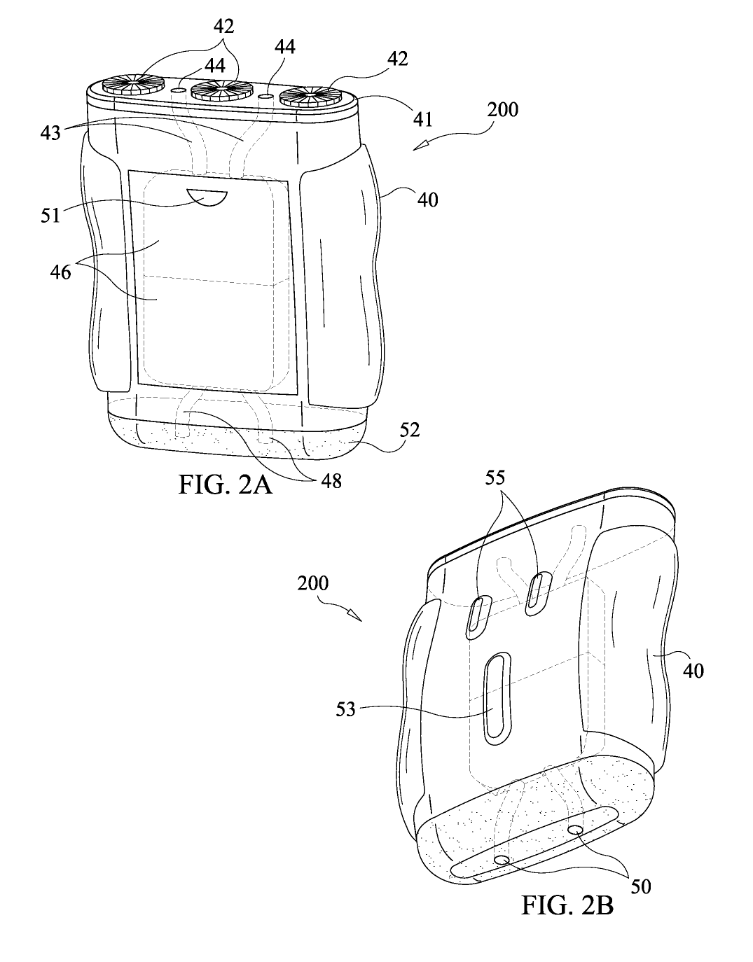

Referring to FIG. 2A, another embodiment of an integrated shaver 200 according to the present invention is presented having a body 40 comprising a shaving head 41 with at least a cutter 42 and at least an orifice 44 suitable for delivery of a lotion, gel or cream to the face or body of user. The shaver body 40 comprises a bottom application portion 52 preferably of a material adaptable for application of lotion, gel or cream to the body by a user. The shaver 200 of the present invention preferably has at least a cartridge, reservoir or container 46 for use in holding the gel, lotion or cream. A discharge channel 43 is adapted to convey the gel, which nomenclature shall be used interchangeably to include lotion, cream or any suitable content for the intended purpose of application to the skin of a user. A latch or opening aid 51 is preferably included to provide for the opening or necessary recharge of the cartridge 46 for the shaver 200 according to the present invention. It is informative that the discharge channel 43 is adapted to convey the gel to the top of the shaver 200. Alternatively or in combination, at least another cartridge 46 is included in the cavity wherein at least another cartridge leading upwards to the top of the shaver is presented. Said cartridge 46 may be provided with at least a discharge channel 48 adapted to convey a gel to the bottom of the shaver 52.

In the present invention, shown in FIG. 2B, at least a bottom orifice or discharge outlet 50 is presented for the application of an aft shave or suitable lotion or gel to the skin of the user. A readout button, sensing gauge or other suitable meter 53 may be included, according to the present invention. Such gauge is usable to monitor the content of the cartridges or usable to serve any needed purpose to facilitate the efficiency and effectiveness of delivering needed lotion or gel to the body of the user. The body 40 may include switches 55 usable to trigger the release or delivery of said gel to the orifice 44 or 50 of the shaver 200. The shaver 200 of the present invention may include actuators, feeding mechanisms or other delivery enhancing equipment (not shown) to facilitate the delivery of said lotion to the body of a user. It is reasonable to expect a pre-shave or similar lotion or lubricant to be charged in the cartridge provided for top delivery while an aftershave of similar lotion or gel be charged in the cartridge providing delivery to the bottom portion of the shaver 200 of the present invention. The switch 55 or meter 53 may be located on any preferable part of the shaver body 40, which may be on the opposite end or on either side of the body 40.

The present invention provides the use of a shaver having cutters on one end and an applicator on the second end. The cutter end of the shaver is preferably adapted with at least an aperture to discharge at least a lotion, said lotion suitable to flow through the discharge mechanism to the skin of a groomer. In a grooming process, a user activates the flow or discharge of the lotion, pre-shave gel or cream to the cutting end of the shaver. The activation may be independent of the cutting or shaving process; or can be made to occur during the shaving process. A cartridge adaptable for use in the shaver of the present invention may be produced to force an outflow of lotion with or without the use of actuators or pumping mechanism. Such cartridges may be vacuum-fed or otherwise prepared to force out lotion without use of external pumping devices. When pumping mechanisms are utilized, such equipment is preferably adapted to fit in the body of the shaver.

The other end of the shaver is preferably fitted with an applicator suitable for use in applying aftershave or such similar lotion to the skin of a groomer after a shave. This end is similarly fitted with at least an aperture and connections to at least a cartridge holding the preferred lotion or gel for use on the skin. In a manner similar to the cartridge discussed above for the top end of the shaver, this cartridge and the discharge mechanism are preferably adapted to operate with or without the use of an actuator or pumping mechanism. In instances wherein a pumping mechanism is employed, such equipment is preferably suitable to be incorporated in the body of the shaver according to the present invention.

The integrated shaver of the present invention may preferably be powered as electric equipment or via a mechanically loaded system with a wound-up system. The former may include the use of alternate or direct current systems and/or batteries, whether or not rechargeable. An electric shaver as an embodiment of the present invention may include a system without a stored or charged up battery.

The shaver of the present invention may be fitted with a gauge or metering apparatus usable to monitor the level of lotion in the cartridge. Other useful outcomes of the metering gauge include adapting it to cooperate with a pumping mechanism, when and if included.

Another embodiment of the present invention includes a shaving clipper suitably adapted to provide a delivery channel to the front clipper end of the integrated shaver and a delivery system at the other end of the shaver. A clipper system according to the present invention meets the system as disclosed except for the front end being a clipper instead of a rotary cutter or other adaptable ends suitable for personal grooming.

An applicator usable on the bottom end of the shaver of the present invention may be provided in any form suitable to cause the spread or use of the lotion on the skin of the groomer. Reasonably, the applicator may be foam or such suitable material based, and may be washable, removable or reusable as need or technology provides capacity.

The use of the demonstrated embodiments is not deemed a limitation of the scope of this invention. Other designs are practical and plausible, including design changes to accommodate ergonomic needs of groomers, aesthetic appearances or other desires that may or may not be driven by market forces or conditions including efficiency and effectiveness of operation.

Having thus described the preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

What is claimed:

1. An integrated shaver, said shaver comprising:
a body having a shaver at a first end and an applicator at a second end;
at least a cartridge disposed to be insertable in the body of the shaver;
at least a discharge channel disposed to be connectable to the cartridge;
at least an aperture disposed on the first or second end of the shaver; wherein a lotion charged in the cartridge is deliverable via said at least a discharge channel and said at least an aperture to a skin of a user during operation or said use of the shaver.

2. The shaver of claim 1, wherein the shaver includes at least one cutter.

3. The shaver of claim 1, wherein the shaver is powered by electricity.

4. The shaver of claim 1, wherein the shaver is mechanically powered.

5. The shaver of claim 1, wherein the applicator comprises a soft tissue end suitable to apply aftershave lotion.

6. The shaver of claim 1, wherein the cartridge delivers the lotion without use of an actuator or pump.

7. The shaver of claim 1, wherein the cartridge mechanism includes an actuator to facilitate the delivery of lotion to the discharge channel.

8. The shaver of claim 7, wherein the actuator is suitable for metering the lotion through the discharge channel.

9. The shaver of claim 1, wherein apertures are locatable on the first and second end of the shaver.

10. The shaver of claim 1, wherein the top dispensing lotion is a pre-shave lotion.

11. shaver of claim 1, wherein the bottom dispensing lotion is an aftershave lotion.

12. The shaver of claim 1, wherein the top dispenser operates independent of the cutter.

13. shaver of claim 1, wherein the bottom dispenser is a replaceable foam applicator.

14. A method of personal grooming, comprising:
using an integrated shaver having a shaver at a first end and an applicator at a second end, at least a cartridge disposed to be insertable in the body of the shaver, at least a discharge channel disposed to be connectable to the cartridge, and at least an aperture disposed on the first or second end of the shaver; wherein the method includes discharging at least a lotion to the skin of a groomer independent of the shaving process or discharging lotion to the skin of a groomer after shaving.

15. The method of claim 14, wherein the step of shaving includes release of lotion.

16. The method of claim 14, wherein the integrated shaver is electric.

17. The method of claim 14, wherein the use of the bottom applicator includes the activation or discharge of aftershave lotion.

18. The method of claim 14, wherein the discharge of lotion to the end includes use of an actuator or pumping mechanism.

19. The method of claim 14, wherein the use of the shaver includes recharge of at least a pre-shave or aftershave lotion.

20. An integrated shaver, said shaver comprising:
a body having a clipper at a first end and an applicator at a second end;
at least a cartridge disposed to be insertable in the body of the clipper;
at least a discharge channel disposed to be connectable to the cartridge;
at least an aperture disposed on the first or second end of the shaver; wherein a lotion charged in the cartridge is deliverable via said at least a discharge channel and said at least an aperture to a skin of a user during operation or said use of the shaver
